(19) United States
(12) Patent Application Publication
(10) Pub. No.: US 2026/0042666 A1
(43) Pub. Date: Feb. 12, 2026

(54) REGOLITH OXYGEN EXTRACTION SYSTEM

(71) Applicant: Blueshift, LLC dba Outward Technologies, Broomfield, CO (US)

(72) Inventors: Andrew Timon Brewer, Wheat Ridge, CO (US); Austin Kenneth Miller, Gold Hill, CO (US); Ryan Garvey, Lafayette, CO (US)

(73) Assignee: Blueshift, LLC dba Outward Technologies, Broomfield, CO (US)

(21) Appl. No.: 19/192,712

(22) Filed: Apr. 29, 2025

Related U.S. Application Data
(60) Provisional application No. 63/680,470, filed on Aug. 7, 2024.

(51) Int. Cl. C01B 13/02; B01J 6/00; B64G 4/00

(52) U.S. Cl. CPC C01B 13/0203; B01J 6/00; B01J 19/0053; B64G 4/00

(57) ABSTRACT

A regolith oxygen extraction system that extracts oxygen and produces molten regolith by processing and heating a continuous regolith feed. The system feeds regolith through a vertical hopper to a reaction chamber, the regolith itself sealing the inlet to the reaction chamber while maintaining continuous flow. The heated regolith reacts within the reaction chamber to produce oxygen and processed regolith. The processed regolith is removed from the reactor chamber through an extrusion nozzle, the processed regolith itself sealing the produced gases within the reactor chamber while maintaining continuous flow of processed regolith. The system employs non-contact reaction temperature measurement and rapid oxygen content measurement in the regolith upstream and downstream of the reaction zone, and may be integrated with multiple oxygen extraction methods.

### CROSS-REFERENCE TO RELATED APPLICATION

This application is a nonprovisional patent application of and claims the benefit of U.S. Provisional Ser. No. 63/680,470 titled “Regolith Oxygen Extraction System” filed Aug. 7, 2024, the disclosure of which is hereby incorporated herein by reference in entirety for all purposes.

### STATEMENT

This invention was made with government support under Contract Nos. 80NSSC22PA966 and 80NSSC23CA075, each awarded by the National Aeronautics and Space Administration (NASA). The government has certain rights in the invention.

### FIELD

The disclosure relates generally to a regolith oxygen extraction system, in particular to a system that extracts oxygen and produces molten regolith by processing and heating a continuous regolith feed.

### BACKGROUND

Oxygen extraction from lunar and Martian regolith has been a topic of interest to NASA for over five decades for the disruptive benefits that In Situ Resource Utilization (ISRU) will have on space exploration by reducing costs and logistical constraints for developing in-space infrastructure. Several methods for O₂ generation have been explored with laboratory-scale proofs of concept over those years as NASA's priorities evolved and shifted away from and back to the Moon. In 2005, NASA initiated the ISRU Project in the Exploration Technology and Development Program (ETDP) in order to promote and facilitate ISRU technology development across the board of potential applications. ETDP was cancelled and the ISRU Project was re-established through the Exploration Space Mission Directorate. For oxygen extraction, the ISRU Project selected three extraction methods to be developed over the five-year program ranging from low risk/low performance to high risk/high performance. Hydrogen reduction of ilmenite was selected as a low risk/low performance technology and brought to a TRL 5 as a well-known, multi-step process that does not require molten regolith (<1,000° C.) but requires an iron oxide rich regolith. Carbothermal reduction was selected as a medium risk/medium performance technology and brought to TRL 5 as a well-known, multi-step process requiring a reactant gas (methane) and molten regolith handling. Molten Regolith Electrolysis (MRE) was selected as a high risk, high performance technology and brought to TRL 3 as a single step process capable of producing multiple pure metals and nonmetals in addition to oxygen but requiring significant advancements for handling molten metals and pure oxygen at high temperatures. Vapor phase pyrolysis (i.e. vacuum pyrolysis) was not included in NASA's development focus, likely due to its high temperature and energy requirements (2,000°-6,000° C.), but has also been explored in depth and holds great potential if coupled with an appropriate thermal delivery system.

Current oxygen extraction reactors lack the ability to continuously feed regolith into a reactor and remove processed regolith from the reaction zone. The disclosed regolith oxygen extraction system, aka the Feed and Removal of Regolith for Oxygen Extraction (FaRROE) system, enables continuous operation with increased service life with innovative non-mechanical valves in addition to oxygen content monitoring in unprocessed and processed regolith.

The disclosed FaRROE system enables integration with all of these extraction processes and can easily be adapted to new processes that may be developed in the future. FaRROE provides an end-to-end regolith feed, oxygen extraction, and slag extrusion in a continuous process, and establishes scaling relationships and requirements for full-scale system deployment. The FaRROE system employs non-mechanical valves to enable high throughputs and continuous processing for a range of oxygen extraction processes to be implemented on the Moon, while enabling the extruded slag to be utilized through secondary refining and/or a host of manufacturing processes.

FaRROE enables the transfer of regolith from excavators to within a lunar oxygen extraction reactor, and the transfer of processed regolith from the reduction reactor to a holding hopper or the lunar surface. The system incorporates noncontact temperature measurements of the regolith within the reactor using a 2-color pyrometer to monitor regolith phase change and temperatures up to and exceeding 2,000 C. The innovative design of the FaRROE system incorporates non-mechanical valves at the reactor inlet and outlet to enable the continuous feed of regolith into and out of an enclosed reactor at high processing rates (>25 kg/hr) with no moving parts coming into contact with the regolith. Sealing of the reactor inlet is produced through a vertical tube hopper packed with unprocessed regolith, creating a tortuous path for product gases and preventing their escape from the reactor chamber. An extrusion nozzle or a second vertical tube hopper at the reactor outlet enables the controlled removal of processed regolith and formation of a liquid seal preventing the escape of product gases. Utilizing unprocessed and processed regolith as the sealing mechanisms reduces mass, complexity, and likelihood of mechanical failure of the system. The extraction of oxygen is monitored through two redundant systems to measure oxygen production rate, system efficiency, and leak rate. Mineral-oxide content is measured continuously at the unprocessed inlet feed and processed outlet feed. The oxygen and/or other product gases generated within the reactor are monitored through in-line gas analysis. FaRROE may be integrated with every known high-temperature oxygen extraction method for regolith to enable continuous processing at high feed rates through a lightweight, durable design to ensure long-term continuous operation in the harsh lunar environment.

### SUMMARY

In one embodiment, a regolith oxygen extraction system is described, the system comprising: a vertical tube hopper defining a hopper volume and configured to receive a first regolith stream at a hopper inlet and output the first regolith stream at a hopper outlet; a conveyor configured to transport the first regolith stream at or adjacent the hopper outlet to form a regolith reaction stream; a reactor chamber having a chamber enclosed volume and configured to receive the regolith reaction stream, transfer heat to the chamber enclosed volume, output a molten regolith stream, and output a production oxygen stream; an extrusion nozzle configured to extrude the molten regolith stream; and a controller configured to control at least an extrusion rate of the molten regolith stream; wherein: the first regolith stream flows from the hopper inlet to the hopper outlet; the heat transferred to the regolith reaction stream contained within the chamber enclosed volume produces a reaction at a reaction zone that creates molten regolith and oxygen; the molten regolith stream formed from the molten regolith exits the reaction chamber at an extrusion rate through the extrusion nozzle; the oxygen forms the production oxygen stream that exits the reaction chamber at an oxygen production rate through an oxygen outlet and forms a backflow oxygen stream that flows at least from the hopper outlet to the hopper inlet; the first regolith stream forms a gas seal within the hopper volume that restricts the backflow oxygen stream and reduces a backflow oxygen stream flow rate of the backflow oxygen stream; and the molten regolith stream forms a liquid seal that restricts the oxygen from exiting through the extrusion nozzle.

In one aspect, the system further comprises one or more agitation mechanisms coupled to the vertical tube hopper, one or more the agitation mechanisms operating to mitigate clogging of the first regolith stream. In another aspect, the system further comprises at least one of a temperature sensor configured to measure a reactor chamber temperature, an optical sensor configured to measure an oxygen concentration of the production oxygen stream, a first Raman spectrometer sensor configured to measure a mineral-oxide content of the first regolith stream, the first or a second Raman sensor configured to measure a mineral-oxide content of the molten regolith stream, a third Raman sensor configured to measure a mineral-oxide content at a selected location, and a fourth Raman sensor configured to measure a mineral-oxide content at multiple selected locations. A Fourier-Transform Infrared Spectroscopy (FTIRS) or any device for measuring spectral characteristics of material may be used interchangeably with one or more of the Raman sensors in the system, or alternate spectrometer or spectroscopy sensor. In another aspect, the heat transferred to the chamber enclosed volume is provided by one of a solar-thermal means, a solar heated means, an electrical-resistive means, an induction means, an electrical Joule heating means, and a microwave means. In another aspect, the backflow oxygen stream rate is less than 1% of the oxygen production rate. In another aspect, a rate of flow of the oxygen stream exiting through the extrusion nozzle is less than 1% of the oxygen production rate. In another aspect, the regolith is lunar regolith.

In one preferred embodiment, the backflow oxygen stream rate is less than 1% of the oxygen production rate. In a more preferred embodiment, the backflow oxygen stream rate is less than 0.5% of the oxygen production rate. In a most preferred embodiment, the backflow oxygen stream rate is less than 0.05% of the oxygen production rate.

In another embodiment, a method of using a regolith oxygen extraction system is described, the method comprising: providing a regolith oxygen extraction system comprising: a vertical tube hopper defining a hopper volume and having a hopper inlet and a hopper outlet; a horizontal conveyor; a reactor chamber having a chamber enclosed volume and an oxygen outlet; an extrusion nozzle in fluid communication with the reactor chamber; and a controller; supplying a first regolith stream to the hopper inlet; flowing the first regolith stream from the hopper inlet to the hopper outlet; receiving the first regolith stream by the conveyor at or adjacent to the hopper outlet to form a regolith reaction stream; transporting the regolith reaction stream to a regolith reaction stream port; flowing the regolith reaction stream from the regolith reaction stream port to the chamber enclosed volume; forming molten regolith and oxygen by applying heat to the regolith reaction stream to cause a reaction in a reaction zone; extruding the molten regolith through the extrusion nozzle; and outputting the oxygen through the oxygen outlet.

In one aspect, the method further comprises the step of agitating the first regolith stream using an agitation mechanism coupled to the vertical tube hopper, the agitation mechanism mitigating clogging of the first regolith stream. In another aspect, the method further comprises the step of controlling a rate of molten regolith extrusion through the extrusion nozzle, the rate of molten regolith extrusion controlled by control of at least one of: control of an extrusion nozzle temperature and a reactor chamber internal pressure.

In another aspect, the regolith oxygen extraction system further comprising the step of controlling a rate of molten regolith extrusion through control of heat provided to at least one of the extrusion nozzle and the reactor chamber, the heat produced by at least one of induction coils, a resistive wire, and a microwave source. In another aspect, the heat applied to the regolith reaction stream is provided by one of a solar-thermal means, a laser heated means, an electrical-resistive means, an induction means, an electrical Joule heating means, and a microwave means. In another aspect, the vertical tube hopper of the regolith oxygen extraction system further comprises a set of directionally biased flow restrictors that increase a differential pressure of the regolith oxygen extraction system. In another aspect, the regolith oxygen extraction system further comprises a crucible configured to contain the molten regolith, induction coils configured to generate induction heat, and a susceptor positioned radially exterior to the crucible. In another aspect, the method further comprises the step of vertically translating the susceptor to provide at least one of: i) controlled heating of the molten regolith, and ii) flow control of the molten regolith extruding through the extrusion nozzle by controlling nozzle temperature. In another aspect, the method further comprises the step of alternating power inputs of vertically oriented heat sources controlling heating of the molten regolith. In another aspect, the step of vertically translating the susceptor also provides flow control of the molten regolith extruding through the extrusion nozzle. In another aspect, the method further comprises the step of controlling a temperature of the molten regolith by control of a flow rate of the first regolith stream.

In another aspect, the conveyor comprises an agitation mechanism operating to fluidize and promote forward flow of the regolith reaction stream and at least one weir to control forward flow and prevent backflow of the first particle stream.

In yet another embodiment, a particle and gas extraction system is described, the system comprising: a vertical tube hopper defining a hopper volume and configured to receive a first particle stream at a hopper inlet and output the first particle stream at a hopper outlet; a conveyor configured to transport the first particle stream at or adjacent the hopper outlet to form a particle reaction stream; a reactor chamber having a chamber enclosed volume and configured to receive the particle reaction stream, transfer heat to the chamber enclosed volume, output a molten particle stream, and output a production gas stream; an extrusion nozzle configured to extrude the molten particle stream; and a controller configured to control at least an extrusion rate of the molten particle stream; wherein: the first particle stream flows from the hopper inlet to the hopper outlet; the heat transferred to the particle reaction stream contained within the chamber enclosed volume produces a reaction at a reaction zone that creates molten particles and a gas; the molten particle stream formed from the molten particles exits the reaction chamber at an extrusion rate through the extrusion nozzle; the gas forms the production gas stream that exits the reaction chamber at a gas production rate through a gas outlet and forms a backflow gas stream that flows at least from the hopper outlet to the hopper inlet; the first particle stream forms a gas seal within the hopper volume that restricts the backflow gas stream and reduces a backflow gas stream flow rate of the backflow gas stream; and the molten particle stream forms a liquid seal that restricts the gas from exiting through the extrusion nozzle. In one aspect, the particle and gas extraction system further comprises a tube outlet connected to the reaction chamber and configured to output any mixed granular material formed from the molten particles.

By way of providing additional background, context, and to further satisfy the written description requirements of 35 U.S.C. § 112, the following set of references are incorporated by reference in entirety for all purposes: US Patent Appl Publ Nos. 2022/0274077 published 1 Sep. 2022 to Brewer et al (“SCORCHER”); and 2022/0268488 published 25 Aug. 2022 to Brewer et al (“SCORCHER+”).

The term “regolith” means any blanket of unconsolidated, loose, heterogeneous superficial deposits that cover solid rock, and may include soil, dust, broken rocks, and other related materials. Regolith is present at least on Earth, the Moon, Mars, and some asteroids.

The phrase “working material” means any material heated by the regolith oxygen extraction system and may include regolith, granular material, particles, and any article of any phase of matter or combination of phases of matter.

The term “crucible” means a container in which metals or other substances may be melted or subjected to very high temperatures.

The term “weir” means a barrier across a flow channel that alters the flow characteristics of the fluid or material flowing through the channel.

The regolith oxygen extraction system may receive and react particles to include regolith and working material, the working material being any granular material.

The term “substantially” means almost exactly and differing from actually in a de minimus manner and when used in a quantitative context, less than 1% different.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having”can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The disclosed methods and/or systems may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA.®. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a schematic representation of one embodiment of a regolith oxygen extraction system;

FIG. 2 depicts another embodiment of a regolith oxygen extraction system as positioned on the lunar surface;

FIG. 3 is a flow chart of a method of use of the regolith oxygen extraction system of FIG. 1;

FIG. 4A depicts another embodiment of a regolith oxygen extraction system;

FIG. 4B depicts a blow-up of a portion of FIG. 4A;

FIG. 4C depicts another blow-up of a portion of FIG. 4A;

FIG. 5 depicts aspects of a slag extrusion seal system used in embodiments of a regolith oxygen extraction system;

FIG. 6A depicts an experimental prototype design of the extrusion portion of a regolith oxygen extraction system;

FIG. 6B describes another experimental prototype design of the extrusion portion of a regolith oxygen extraction system;

FIG. 7 depicts another experimental prototype design of the extrusion portion of a regolith oxygen extraction system;

FIG. 8 depicts a spectroscopy system engaged with an experimental prototype design of a regolith oxygen extraction system;

FIG. 9A depicts one embodiment of the conveyor element of a regolith oxygen extraction system;

FIG. 9B depicts another embodiment of the conveyor element of a regolith oxygen extraction system;

FIG. 9C depicts another embodiment of the conveyor element of a regolith oxygen extraction system; and

FIG. 10 depicts another embodiment of an element of a regolith oxygen extraction system.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

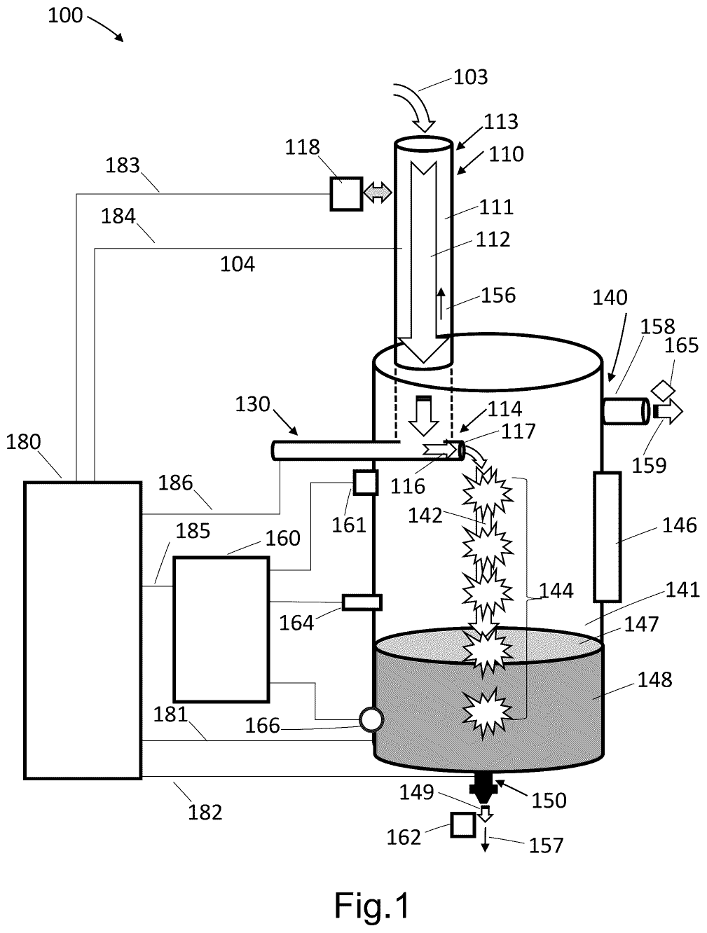

The disclosed devices, systems, and methods of use will be described with reference to FIGS. 1-10. Generally, systems and methods to provide a regolith oxygen extraction system and method of use are provided. The term “system” or “FaRROE” or the phrase “Feed and Removal of Regolith for Oxygen Extraction” may be used to refer to an embodiment of the regolith oxygen extraction system. The term “method” may be used to describe an embodiment of a method of use of the regolith oxygen extraction system.

A regolith feed and removal system for oxygen extraction from regolith with non-contact reaction temperature measurement and rapid oxygen content measurement in regolith upstream and downstream of the reaction zone is disclosed. The regolith feed system may be integrated with varied oxygen extraction methods to enable continuous feed of material into and out of the reaction zone while maintaining a pressure sealed reactor chamber.

The disclosed Feed and Removal of Regolith for Oxygen Extraction (FaRROE) system implements two features that act as non-mechanical valves utilizing the regolith itself for sealing the inlet and outlet of the reactor chamber while maintaining continuous flow of regolith through the system. The regolith itself is used for sealing the inlet and outlet of the reactor chamber while maintaining continuous flow of regolith using non-mechanical valves and minimal moving parts. On the inlet, a vertical tube hopper creates a gas seal with a column of unprocessed regolith that produces a tortuous path preventing the leakage of product gases as the regolith is fed into the reactor chamber. On the outlet, a system for continuous slag extrusion creates a liquid seal with molten processed regolith to prevent leakage of product gases as it is extruded out of the reaction chamber. In some embodiments, additionally or alternatively one or more seals are formed that prevent or restrict material and or gases (if present) from flowing back into the reactor chamber. Process monitoring may be achieved, e.g., with a 2-color pyrometer calibrated for measuring regolith temperature through phase changes, an optical gas sensor for measuring product gas concentrations on the gas outlet stream of the reactor, a fast response Fourier Transform Infrared Spectroscopy (FTIRS) module for measuring mineral-oxide content in the unprocessed and processed regolith streams, or any spectrometer or spectroscopy sensor.

Benefits of the FaRROE system include reactor chamber sealing using in situ materials (e.g., regolith) and minimal moving parts, non-contact temperature measurement of the reaction zone that can be used to control and optimize the oxygen extraction process, real-time O₂ measurements that can inform process efficiency and signal the need for periodic servicing, a feed system which accommodates both continuous and batch processes, extraction process-agnostic design for wide adaptability between State-of-the-Art (SOA) oxygen extraction methods, and secondary resource utilization of extruded slag for manufacturing, long duration thermal energy storage, and/or for smelting and secondary refining. The system includes reactor chamber sealing using in situ materials (regolith) and minimal moving parts, non-contact reaction temperature measurement that can be used to control and optimize the oxygen extraction process, real-time oxygen measurements that can indicate efficiency of the process and signal whether servicing is required, continuous processing of regolith for oxygen extraction rather than requiring a batch process, extraction process agnostic design for wide adaptability, and secondary resource utilization of extruded slag for part fabrication, long duration thermal energy storage, or for smelting and secondary refining.

FIG. 1 provides a schematic representation of one embodiment of a regolith oxygen extraction system 100. The regolith oxygen extraction system 100 comprises a vertical tube hopper 110, a conveyor 130, a reaction chamber 140 engaged with an extrusion nozzle 150, and a system controller 180 engaged with a process monitor 160.

A regolith supply 103 enters the vertical tube hopper 110 at hopper inlet 113 and flows through hopper volume 111, forming a first stream of regolith i.e. a first regolith stream 112 that exits the hopper 110 at hopper outlet 114. One or more agitation mechanisms 118 engage with the vertical tube hopper 110 to urge flow of the first regolith stream 112 through the hopper 110 and/or to prevent or mitigate clogging of the first regolith stream 112 in the hopper volume 111. (Various agitation mechanisms and associated system elements to prevent or mitigate clogging are described in more detail below). The conveyor 130 receives the first regolith stream 112 at a location at or near or adjacent the hopper outlet 114 to form a regolith reaction stream 116. In the embodiment of FIG. 1, the receipt by the conveyor 130 of the first regolith stream 112 occurs within a chamber enclosed volume 141 of the reaction chamber 140. (Various embodiments for or relating to the two regolith streams 112 and 116 are described in more detail below). The regolith reaction stream 116 is then output or ported from regolith reaction stream port 117 and is received by the reaction chamber 140. The regolith reaction stream 116 then receives thermal energy e.g. heat at least within a reaction zone 144, forming a reaction zone regolith stream 142 and producing oxygen and molten regolith 148. The thermal energy is provided by any of several means, such as, e.g., a solar-thermal means, a laser heated means, an electrical-resistive means, an induction means, an electrical Joule heating means, and/or a microwave means. In one embodiment, the conveyor is horizontal or substantially horizontal. In one embodiment, the conveyor is positioned or disposed such that it is substantially perpendicular to the vertical tube hopper.

The reaction zone 144 may be any combination of the area of regolith particle fall (thus occurring within the reaction zone regolith stream 142), on or adjacent an upper surface of the molten regolith, i.e., at the molten regolith upper surface 147, and within the molten regolith 148 pool. Stated another way, the reaction zone 144 may occur exclusively within reaction zone regolith stream 142, exclusively at molten regolith upper surface 147, exclusively within molten regolith 148 pool, or in any combination of these locations (e.g., both at molten regolith upper surface 147 and within molten regolith 148 pool).

The vertical tube hopper consists of a column of regolith to feed regolith into a reactor while preventing the flow of gases out of the reactor. There are no valves within the granular regolith feed, with the regolith itself creating a drag force on the gas when there are enough gas particles that it acts like a continuum (i.e. regolith pore spaces act like a network of very small pipes), and makes up a tortuous path for individual gas particles when it behaves as a rarefied gas (i.e. acts like a labyrinth seal with the gas particles bouncing randomly within the pores between regolith grains making it difficult to find an exit). This configuration most commonly takes the form of a vertical or near-vertical column of regolith where the top of the column is exposed to a vacuum environment on the Moon and the bottom of the column is exposed to the internal reactor pressure. Regolith flows most commonly from top to bottom with this being fed by gravity although alternate embodiments are possible such as a fully packed stick-slip vibratory particle elevator or a tightly packed Olds Elevator (described below) at various orientations.

The benefits of the regolith-based seal are that no valves are required, there are no high wear surfaces, there are no sealing surfaces that could be contaminated by the granular regolith, and component hardware is lightweight. Percussive impacts along the outside of the column increase downward flowability of the regolith without causing fluidization of the regolith. Traditional modes of vibration are likely to cause fluidization and an increase in the leak rate of gas through the column. Other mechanisms exist for increasing flow of regolith through the column without allowing gas to escape. These include a membrane on the inside of the column selectively expanding and contracting along longitudinal sections of the column to remove confinement on packets of regolith to allow them to fall and then apply confinement again once it has passed. Restrictors (such as directionally based flow restrictors) may be placed within the column to allow regolith to flow downwards but which reduces the likelihood that regolith moves upwards or that the regolith will become fluidized. A weighted mass or partial lid may also be placed on the top of the regolith to apply some additional downward force to reduce potential for blowout in low gravity conditions. Different cross-sections may be possible for the regolith column which could include changes in area along the column.

The conveyor serves as a mechanism for extracting regolith from the granular column and depositing it to the reaction zone. This hardware element is located at the bottom of the granular regolith column and draws regolith from the column at a controllable mass flow rate and deposits it into a reaction zone. This mechanism may take the form of, for example, an auger, a loop seal (a pneumatic conveyance method used in terrestrial industry), and/or a vibratory weir (or vibratory loop seal) in which the pneumatic source in a loop seal is replaced by a vibratory system. Such embodiments are described below.

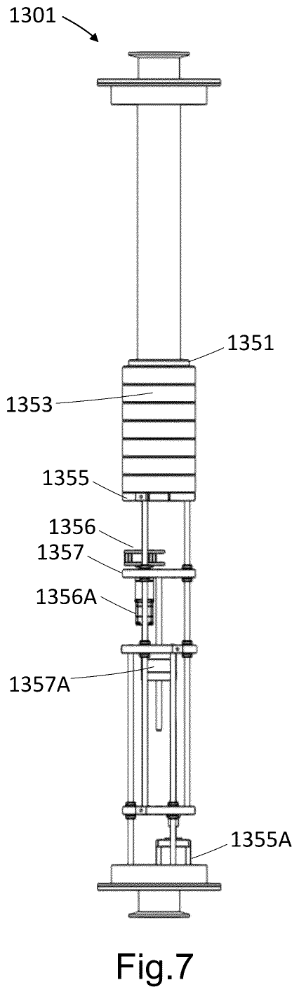

The molten regolith 148 forms a molten regolith stream 149 that is extruded from extrusion nozzle 150. (In some embodiments, a vertical tube or vertical tube hopper may be used instead of nozzle, as described below). The molten regolith stream 149 forms a liquid seal at or near or adjacent to the extrusion nozzle that restricts the oxygen produced from the reaction, reactant gases, and other product gases from exiting through the extrusion nozzle 150. Various techniques and/or system components described below (e.g. see FIG. 7) are employed to restrict the outflow of oxygen (i.e. the oxygen extrusion outflow 157) from the reaction chamber through the extrusion nozzle 150.

The oxygen produced from the reaction of the heated regolith stream 142 forms a production oxygen stream 159 that exits the reaction chamber through chamber oxygen outlet 158 and forms a backflow oxygen stream 156 that flows at least from the hopper outlet 114 to or toward the hopper inlet 113. The first regolith stream 112 forms a gas seal within the hopper volume 111 that restricts the backflow oxygen stream 156 and reduces a backflow oxygen stream flow rate of the backflow oxygen stream 156. Various techniques and/or system components described below are employed to restrict the backflow oxygen stream 156 and reduce the backflow oxygen stream flow rate of the backflow oxygen stream 156.

A molten regolith extrusion system provides hardware for controlling the flow of reacted regolith molten slag from the reactor while ensuring a pressure seal with a molten plug.

Process monitor 160 monitors various system processes using one or more sensors, such as a temperature sensor 164 configured to measure a reactor chamber temperature, an optical sensor 165 configured to measure an oxygen concentration of the production oxygen stream, a first fast response Fourier Transform Infrared Spectroscopy (FTIRS) sensor 161 or module configured to measure a mineral-oxide content of the first regolith stream, and a second FTIRS sensor 162 configured to measure a mineral-oxide content of the molten regolith stream 149 once it has cooled to form a solid. (Control connector line between process monitor 160 and optical sensor 165, and between process monitor and second FTIRS sensor 162, not shown for increased clarity). (Note that, in any of the described embodiments, any spectrometer or spectroscopy sensor may be used rather than a FTIRS sensor).

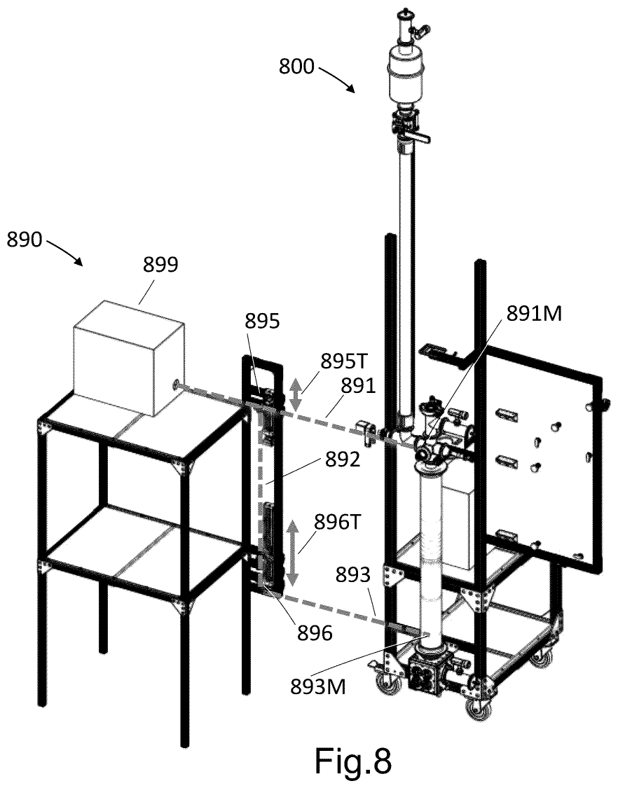

In some embodiments, one or more FTIRS sensors are operated in alternate arrangements or configurations. For example, a FTIRS sensor may be configured to measure a mineral-oxide content at any selected location or configured to measure a mineral-oxide content at multiple selected locations. That is, any given single FTIRS may be used to obtain measurements of metallic oxide compositions at multiple locations through the system through the use of beam splitters and/or other optical components known to those skilled in the art. See FIG. 8. One Raman sensor may be used to take measurements both at the hopper inlet and at the extrusion nozzle outlet, using, e.g., a beamsplitter to select which location the Raman sensor is monitoring.

A Raman spectrometer or any device for measuring spectral characteristics of regolith may be used in addition to or in lieu of the FTIRS sensor or sensors for measuring mineral oxide content and relative concentrations.

Other and/additional sensors to provide system monitoring by process monitor may be employed, such as one or more sensors 166 to measure and/or monitor conditions of the molten regolith 148.

Feedback sensors, controls, and measurement devices are used to monitor the concentrations of metal oxides within the granular regolith being fed into the reactor and the slag material extruded out of the reactor once it has cooled. This enables the user to infer total oxygen being produced by the reactor, chemical composition of the extruded slag material, and overall process efficiency of the reactor (i.e. how much oxygen is being recovered per mass of regolith). Additional sensors exist including distance sensors measuring the height of the top of regolith within the granular column, non-contact temperature sensors measuring the reaction temperatures, thermocouples monitoring temperature of component hardware, non-contact temperature sensors monitoring temperature of extruded material, oxygen sensors, and pressure sensors within the reactor.

The system controller 180 engages with and controls the process monitor 160 by way of controller connection 185 and generally provides control of the systems and processes of the regolith oxygen extraction system 100. For example, the system controller 180 is configured to control the extrusion rate of the molten regolith stream 149 by way of controller connection 182, conveyor 130 operations such as regolith reaction stream 116 feed rate by way of controller connection 186, reactor chamber 140 internal pressure by way of controller connection 181, agitator 118 by way of controller connection 183, and/or processes (e.g. flow rate of first regolith stream 103) associated with the vertical tube hopper 110 by way of controller connection 184. Other controller control functions may include, e.g., control of an extrusion nozzle temperature and/or a reactor chamber internal pressure to control the rate of molten regolith extrusion 149.

Generally, the regolith oxygen extraction system is comprised of a vertical tube hopper that utilizes a column of regolith to seal the reactor chamber from the inlet chamber (or vacuum of the lunar atmosphere); a conveyor that delivers regolith at a specified flow rate from the vertical tube hopper to the reaction zone; and agitation mechanisms that promote downward flow of regolith in the vertical tube hopper.

(Note that in some embodiments, the vertical tube hopper is not substantially vertical, but instead is inclined or horizontal, but nonetheless operates or functions with the disclosed features).

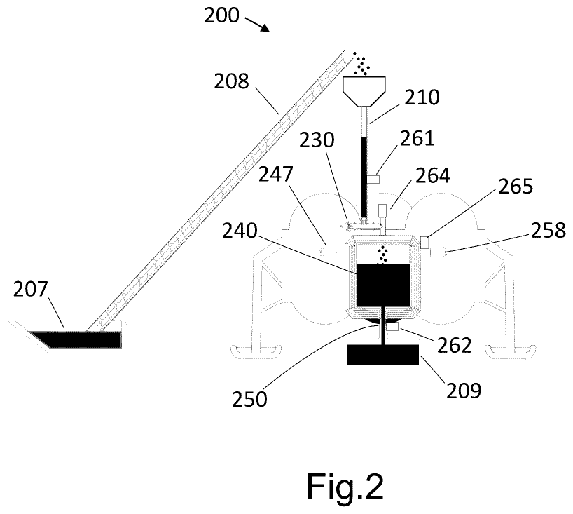

FIG. 2 depicts another embodiment of a regolith oxygen extraction system 200 as positioned on the lunar surface. Many features and elements of the regolith oxygen extraction system 200 are similar to that of the regolith oxygen extraction system 100 of FIG. 1, such as the vertical tube hopper 210 as engaged with the conveyor 230 which together feed regolith to an oxygen production chamber 240, which produce molten regolith extruded via a slag extrusion nozzle 250 and produce a production gas (such as an oxygen gas) that is output from gas outlet 258 as monitored with gas sensor 265. In the regolith oxygen extraction system 200, the temperature sensor 264 is a two color pyrometer (described in more detail below) and two FTIRS 261 and 262 are employed. Also, the regolith oxygen extraction system 200 employs a gas inlet 247 that supplies a gas that facilitates or otherwise enhances or enables the oxygen production and/or molten regolith production. The regolith feed to the vertical tube hopper 210 is provided by ground feed auger 208, which draws regolith from regolith supply bin 207. Also, the molten regolith extruded from slag extrusion nozzle 250 is collected at slag bin 209.

The regolith oxygen extraction system 200, or other embodiments of the regolith oxygen extraction system, may produce non-oxygen product gas streams, a mixed gas product stream, and/or employ a reactant gas (supplied to a reaction area by way of gas inlet 247 in FIG. 2) to facilitate or enable the production of product gas streams. For example, in one oxygen extraction method, a reactant gas such as CO is provided which bonds to oxygen in the regolith and produces a CO₂ product gas stream, such that pure oxygen is never released through the process. In some embodiments, a mixed gas stream is produced by the regolith oxygen extraction system, composed of, e.g., some combination of reactant gas (if used), primary product gas (e.g., pure oxygen or reactant gas after binding to oxygen within the regolith), metal oxides, and/or metals.

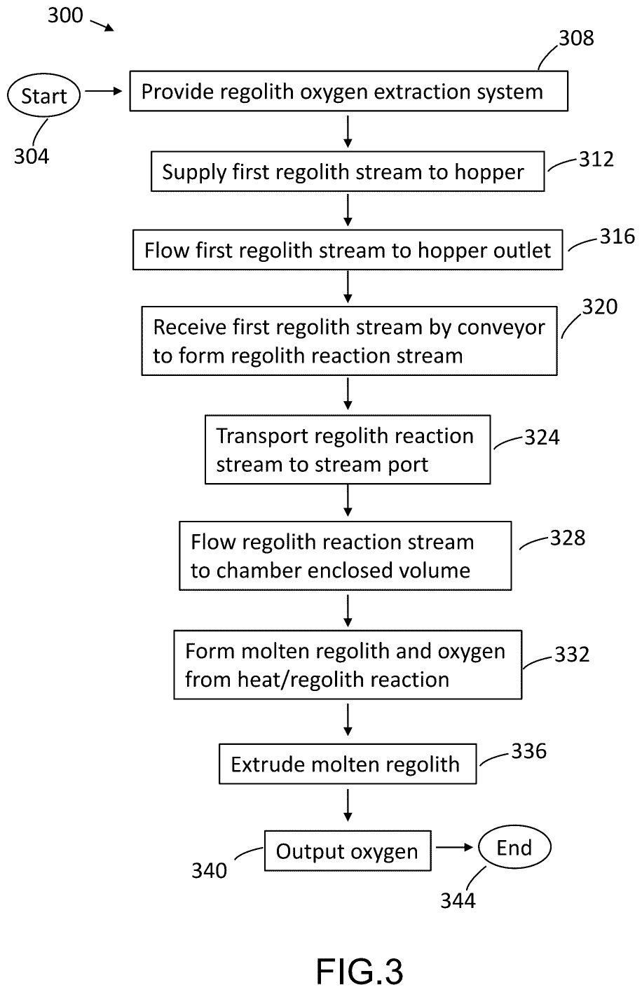

FIG. 3 is a flow chart of a method of use 300 of the regolith oxygen extraction system embodiment of FIG. 1. Note that some steps of the method 300 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 304 and ends at step 344.

After starting at step 304, the method 300 proceeds to step 308. At step 308, a regolith oxygen extraction system is provided, the system similar to those described above, e.g. the system 100 of FIG. 1. After completing step 308, the method 300 proceeds to step 312.

At step 312, a first regolith stream is provided or supplied to the vertical tube hopper. After completing step 312, the method 300 proceeds to step 316.

At step 316, the first regolith flows from the hopper inlet to the hopper outlet. The flow may be facilitated or prevented from clogging by one or more agitation mechanisms. After completing step 3016, the method 300 proceeds to step 320.

At step 320, the first regolith stream is received by the conveyor to form a regolith reaction stream, the stream received at or adjacent the hopper outlet of the vertical tube hopper. After completing step 320, the method 300 proceeds to step 324.

At step 324, the regolith reaction stream is transported by the conveyor to a regolith reaction stream port. After completing step 324, the method 300 proceeds to step 328.

At step 328, the regolith reaction stream flows into the chamber enclosed volume. After completing step 328, the method 300 proceeds to step 332.

At step 332, heat within the chamber enclosed volume causes a reaction of the regolith of the regolith reaction stream to form molten regolith and oxygen. The reaction may occur at any of the reaction stream flow portion, the surface of the regolith pool, and the regolith pool itself, and any combination thereof (e.g., both the regolith pool surface and the regolith pool). After completing step 332, the method 300 proceeds to step 336.

At step 336, the molten regolith is extruded through an extrusion nozzle. After completing step 336, the method 300 proceeds to step 340.

At step 340, oxygen from the reaction is output as a production oxygen stream. After completing step 340, the method 300 proceeds to step 344 and ends.

The FaRROE system, among other things, includes a novel design for producing non-mechanical valves at the inlet and outlet of an enclosed oxygen extraction reactor. The sealing of the reactor inlet is achieved through a vertical tube hopper creating a tortuous path preventing the release of product gases from the reactor into the vacuum of space. The sealing of the reactor outlet is achieved through a molten reacted material forming a liquid seal preventing the outflow of gases while the molten regolith is extruded from the reactor. Additional innovation comes from the control mechanisms put in place to vary flow rate of reacted molten material out of the reactor. This control is achieved through a combination of hydraulic head of the molten material within the reactor, the temperature of the nozzle outlet, the gas pressure within the reactor if this is a tunable parameter for the given oxygen extraction process, and a vertically actuated platform near the nozzle outlet. One or more of these control methods may be used in combination to start/stop flow and finely control the rate of extrusion of reacted material from the enclosed reactor chamber. An alternate embodiment of the reactor outlet consists of a granular column to provide a granular seal for the removal of granular material; mixed granular and molten material; or mixed granular, molten, and solidified processed material from the reactor. Stated another way, in some embodiments a tube outlet is connected to the reaction chamber and configured to output any mixed granular material formed from the molten particles, the tube outlet providing a granular seal. These innovations represent a substantial improvement to current SOA methods for oxygen extraction reactors which currently lack a method for continuously feeding regolith material into and out of an enclosed oxygen extraction reactor on the Moon, Mars, or other planetary bodies. There are several implementations of these methods which result in no moving parts coming into contact with regolith at the inlet, reactor, or outlet feeds.

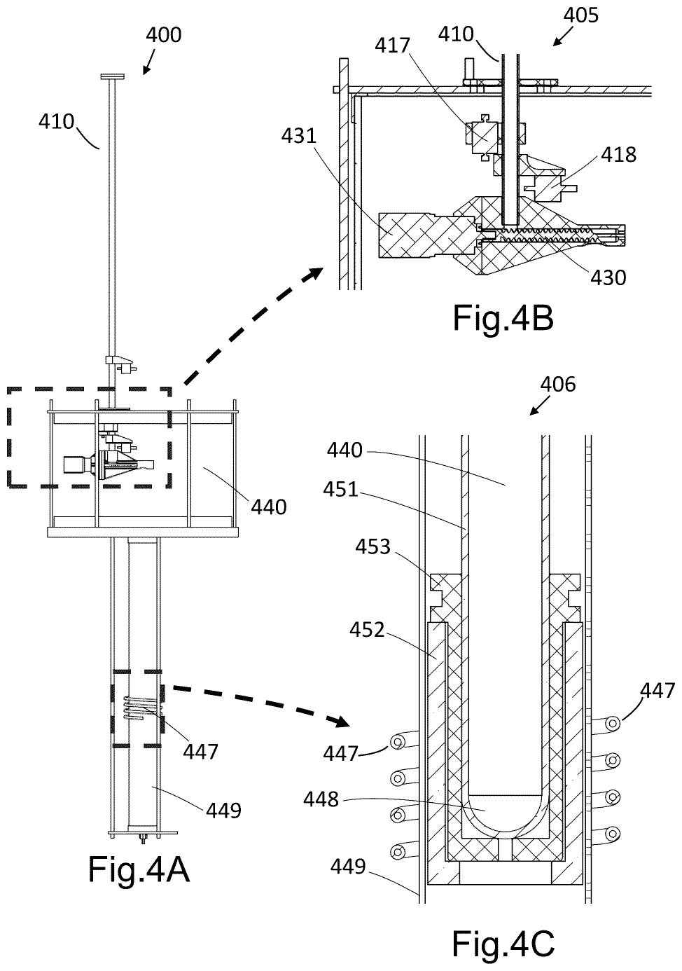

FIGS. 4A-C depict another embodiment of a regolith oxygen extraction system 400, with some similar features or elements to the above embodiments of a regolith oxygen extraction system, e.g. systems 100 and 200. The regolith oxygen extraction system 400 was constructed and evaluated as a prototype system. The regolith oxygen extraction system 400 comprises a vertical tube hopper 410 and horizontal auger 430 (with auger motor 431) that engage with reactor chamber 440 to produce molten regolith 448. The regolith oxygen extraction system 400 is shown with additional detail as to the regolith feed assembly 405 and the regolith extrusion assembly 406. Two agitation mechanisms are shown: a tapping agitator 418 and a vibrating agitator 417. The reaction of the regolith fed to the regolith extrusion assembly 406 is enabled by heat applied by way of induction coils 447. The regolith extrusion assembly 406 comprises alumina crucible/nozzle 451, alumina jacket 452, outlet chamber 449, graphite susceptor 453, and induction coils 447. Note that the regolith particles, as output from horizontal auger 430, may undergo pre-heating and/or a reaction (to turn the regolith particles into oxygen and molten regolith, e.g.) as those regolith particles travel or flow from the horizontal auger 430 and out the regolith feed assembly 405 and into the regolith extrusion assembly 406. In one embodiment, the regolith particles undergo preheating while still in one or both of the vertical tube hopper 410 and the horizontal auger 430.

The regolith oxygen extraction system 400 (a prototype system) comprises three vacuum chambers (inlet, reactor, and outlet), feed and removal subsystems that use regolith alone to seal the reactor chamber from the inlet and outlet chambers while maintaining a constant flow of regolith, an externally mounted induction furnace to heat regolith to greater than 1,400° C. within the reactor chamber, a gas handling system that allowed for pressure to be controlled down to 0.05 psia independently for each of the three chambers while enabling gas to be fed into the reactor chamber for simulating oxygen production, an externally mounted two color pyrometer for measuring reaction zone temperature, an inline optical gas sensor for measuring oxygen content on the product gas stream exiting the reactor chamber, a pressure transducer on each chamber, and two mass flow meters for measuring leak rates through the feed and removal sealing mechanisms. For feasibility and demonstration testing, a vacuum was constantly pulled on the inlet and outlet chambers in order to simulate the lunar atmosphere while gas was added to the reactor chamber to produce a positive pressure differential. In practice, a lunar operational environment would provide the vacuum external to the reactor while the feed and removal system would allow for the addition of feedstock and removal of processed material through a continuous or batch process.

The regolith feed subsystem was composed of a vertical tube hopper that utilized a column of regolith to seal the reactor chamber from the inlet chamber; and a horizontal auger inside the reactor chamber that delivered regolith at a specified flow rate from the base of the vertical tube hopper into the reaction zone. Independent characterization tests of the feed system determined that the sealing capability (leak rate) of the vertical tube hopper was not affected by the feed rate, which enabled system functionality demonstrations well above the target feed rate and indicated that the system throughput was highly scalable. These tests also determined that the leak rate of the vertical tube hopper was sensitive to the regolith column height, bulk density of the regolith, internal surface friction of the tube, tube geometry, and pressure differential.

Implementing a flow restrictor inside the tube which increased surface roughness of the vertical tube prevented regolith from rising in bulk packets as pressurized gas pushed up from the bottom while still allowing for downward flow of regolith through the restrictor. Alternatively or in addition, a directionally biased flow restrictor may be introduced to the tube to further provide resistive force thereby preventing backflow of granular material within the tube while minimizing resistance in the intended direction of the flow of regolith. Pulling vacuum on the system overnight prior to performing a test helped to remove air trapped in the regolith column and maximize bulk density, which minimized void space between grains and prevented the regolith from rising in bulk packets. Maintaining a regolith column height greater than 300 mm prevented the regolith from fluidizing, at which point the leak rate jumped to 12% of the simulated O₂ production rate. Finally, agitation mechanisms consisting of percussive strikers placed external to the tube were implemented to promote downward flow of regolith by preventing arching or the formation of—and breaking up of—bulk packets of regolith which were forced upwards by gases within the reactor.

The regolith removal subsystem further comprises a heated crucible nozzle assembly that utilizes the molten regolith to seal the reactor chamber from the outlet chamber (or vacuum of the lunar environment) while extruding molten regolith slag out of the reactor chamber through an orifice at the bottom of the crucible nozzle; and a vertically actuated platform underneath the crucible nozzle that may be used to control extrusion rate and plug the crucible nozzle orifice for start/stop protocols. The extrusion rate may also be controlled via crucible nozzle temperature control and reactor pressure control.

The crucible nozzle assembly is made up of three components: a long alumina crucible extending from the reactor chamber down into the reaction zone that acted as both the crucible nozzle liner preventing corrosion and the barrier between the reactor and outlet chambers; a graphite annulus surrounding the alumina crucible serving as the induction heating susceptor that enabled the regolith to heat up to melting temperatures inside the alumina crucible and extrude out of an orifice at the bottom of the alumina crucible into the outlet chamber; and an alumina jacket on the outside of the graphite crucible that limited heat loss. This configuration enabled the induction furnace to heat regolith well above the required reaction temperature (>1,400° C.) for extended periods of time (2 hours was demonstrated) without deteriorating the susceptor and is a new technology that may benefit current technology development efforts that utilize induction heating to melt regolith where issues with susceptor design have been reported. The outlet chamber was designed to be long with the high temperature reaction zone at its base so that all silicone sealing surfaces on the reaction chamber base plate were distanced far enough away to prevent melting. It was determined through initial testing of the regolith removal system that the high temperature reaction zone must be at least 250 mm away from the reaction chamber base plate in order for the top of the crucible nozzle assembly to stay below 250° C. and prevent melting of the high temperature silicone gasket and O-ring seals.

Process monitoring was achieved using a two-color pyrometer to monitor reaction temperature and an optical gas sensor to monitor oxygen content in the product gas stream. The pyrometer was positioned external to the FaRROE system and successfully measured the temperature of the crucible nozzle outlet through the quartz wall of the outlet chamber. In a separate, open atmosphere test, the pyrometer was used to measure both the crucible nozzle outlet temperature and the molten regolith temperature at the upper surface of the melt pool.

The prototype FaRROE system 400 of FIG. 4 may be broken down into four subsystems: (1) a reactor chamber where the oxygen extraction process takes place, (2) a regolith feed system with a vertical tube hopper to deliver regolith into the reactor, (3) a regolith removal system with a slag extrusion nozzle and downstream material handling system to remove processed regolith from the reactor, and (4) a process monitoring subsystem made up of a 2-color pyrometer to measure temperature in the reaction zone, an optical gas sensor in line with the product gas outlet stream, and a Raman spectroscopy module sampling the mineral-oxide content of the regolith inlet and outlet streams. Each of these subsystems work together to maximize process efficiency and production rate, regardless of the oxygen extraction process used.

The overall system design relies on a regolith holding bin on the ground surface filled with regolith delivered by excavator robot. An inclined auger or alternative vertical regolith transport mechanism such as those demonstrated in the Over the Dusty Moon Challenge conveys regolith from the holding bin to the vertical tube hopper. The vertical tube hopper is then filled with unprocessed regolith from the vertical regolith transport mechanism and the column of regolith within the hopper creates a pressure seal preventing the escape of product gases from the reactor as regolith is fed into the reactor chamber. The vertical tube hopper is capable of resisting a backpressure generated within the reactor through the weight of the column of regolith, friction between regolith and walls of the hopper, and a tortuous path which is produced by closely packed regolith grains which prevents product gases from being released from the reactor. A FTIRS module is used to continuously sample the unprocessed regolith to measure oxygen content of the regolith feedstock through a mineralogical analysis to determine mineral-oxide concentrations.

A conveyor is then used to transport regolith from the base of the tube hopper into the reaction zone. A benefit of a vibratory conveyor or fluidized conveyor is horizontal conveyance of regolith from the vertical tube hopper to the reaction zone requires no moving parts to come in contact with the regolith. Another option within this design is introduction at the base of a loop seal geometry at the base of the tube hopper, where the loop seal geometry relies on fluidization via aeration and/or vibration to fluidize the regolith at the outlet and to establish regolith flow from the base of the tube hopper to the reaction zone. In the case of vibration to cause fluidization of the regolith, the vibration of the loop seal geometry may be isolated from the tube hopper to minimize the potential of fluidization of regolith within the tube hopper. A weir may be introduced into the loop seal geometry to allow fluidization of the regolith while limiting the backflow of regolith from the outlet back into the tube hopper. Additionally, vibration direction and geometry of the loop seal may be tailored to induce directional motion of the regolith to cause regolith to be fed into the reaction zone as it is being removed from the hopper. Alternatively, aeration and/or vibration causing fluidization of the regolith at the outlet of the tube hopper may be used to cause the regolith drawn from the tube hopper to enter a separate conveyor such as an auger feed, conveyor system, chute, or similar component for delivering regolith from the hopper outlet to the reaction zone. Alternatively, an auger feed system may be used to horizontally convey material directly from the base of the vertical tube hopper into the reaction zone. Potential drawbacks of using an auger include moving mechanical components coming in contact with regolith and inclusion of a rotary feedthrough to seal the motorized auger shaft which may experience wear and increased leak rate after continued exposure to regolith.

Within the reactor chamber, the oxygen extraction process takes place with or without reactant gases (methane for carbothermal reduction, hydrogen for hydrogen reduction, and no reactant gases for vacuum pyrolysis). Thermal power is fed into the reactor as appropriate for the given oxygen extraction process. Permissible heating sources include solar-thermal, laser heating, electrical resistive, induction, and microwave. Reaction temperature is measured continuously using a 2-color pyrometer calibrated specifically for measuring regolith temperature through phase changes. The pyrometer may be placed external to the reactor to monitor temperature through an optical port and bandpass filters applied to measure temperature without being saturated by reflected sunlight when a solar-thermal power source is incorporated into the oxygen extraction process. If desired, the pyrometer could also be positioned inside the reactor chamber if fouling of the optical port becomes troublesome. Gases produced during the extraction process flow through a gas outlet that delivers these product gases to secondary gas handling equipment. An optical gas sensor is mounted in-line with the gas outlet stream for measuring product gas concentrations (either O₂, CO, or H₂O depending on the extraction process), serving as the primary method for monitoring oxygen production within the reactor.

After the oxygen extraction process takes place, the force of gravity coupled with a differential pressure between the reactor and vacuum of space (except in the case of vacuum pyrolysis) forces the molten slag through a nozzle at the bottom of the reactor enabling continuous operation and extrusion of the processed regolith material. After extrusion, the same Raman spectroscopy module that is used at the regolith inlet then samples the processed regolith to measure mineral-oxide concentrations, providing a secondary method for monitoring oxygen production and a direct measurement of extraction efficiency.

The vertical tube hopper significantly reduces the overall complexity of the regolith feed system. With an adequately tall column of regolith, a pressure seal is formed due to the tortuous path that forms between regolith grains which gas must flow through in order to escape the system. Using a vertical, tubular hopper enables the regolith to flow downward into the conveyor by the force of gravity alone with the continuous cross-section of the tube along its length reducing the likelihood of rat-holing, a phenomenon frequently observed in powders and granular materials when incorporating a conical or wedge-shaped hopper design, which would produce a continuous path through which gas could freely flow from the reactor chamber up through the reactor inlet. This vertical tube hopper design, coupled with an external agitation mechanism (e.g. percussive striker) affixed to the outside of the column mitigates clogging, thereby eliminating the issues of bridging that can cause a blockage of the downward flow of regolith which can occur when using a non-vibrating hopper design. Referring to FIG. 1, the vertical tube hopper feeds into the horizontal regolith conveyor that then transports regolith from the hopper into the reactor. The functionality and feasibility of using the vertical tube hopper for maintaining a seal has been established and the maximum pressure differential (4 psi) and minimum regolith column height (500 mm for a 50.8 mm ID tube hopper) were identified for the prototype configuration.

While the vertical tube hopper was proved feasible, there are two alternative embodiments for sealing the reactor chamber inlet. First, the dual gate valve/closed auger design may be used for delivering loose regolith to an isolation hopper that acts as an air lock before then feeding the regolith into the reactor with a second auger or alternative conveyor mechanism. This method allows for regolith to be loaded into the pressure-controlled environment in large batches and fed continuously into the reaction zone without affecting the internal atmosphere of the reactor. Second, a loop seal may be used in drawing regolith from the base of the vertical tube hopper. Loop seals are commonly used in circulating fluidized particle beds to move solids from a low-pressure standpipe to a high pressure riser while preventing gas from moving from the high pressure to the low pressure zone. Like the vertical tube hopper, the loop seal is a non-mechanical valve that utilizes solid particles to isolate chambers operating at differential pressures. However, the loop seal requires a constant gas flow or an externally applied vibration for particle fluidization and proper sealing. Vibration rather than aeration may be used for the fluidization of material within a loop seal geometry to allow material to be removed from the tube hopper while preventing the backflow of regolith and gases back into the hopper.

One major benefit of the FaRROE system is adaptability to interface with multiple oxygen extraction processes including but not limited to hydrogen reduction, carbothermal reduction, Molten Regolith Electrolysis (MRE), and vacuum pyrolysis. The FaRROE hardware design may be adapted with little modifications to accommodate alternate heat sources used for oxygen extraction processes such as solar-thermal, laser heating, electrical resistive, and microwave heating.

The process monitoring subsystem of FaRROE is made up of a 2-color pyrometer, an optical gas sensor, and a Raman spectroscopy module. Reaction temperature is measured continuously using a 2-color pyrometer calibrated specifically for measuring regolith temperature through phase changes. The 2-color pyrometer may be placed externally to the reactor while monitoring reaction temperatures through an optical port. The pyrometer may also be calibrated to measure temperature while filtering out reflected sunlight, making it ideal for oxygen extraction methods employing direct irradiance by concentrated solar power as a heat source. While the pyrometer is ideally positioned outside of the reactor in the proposed FaRROE system to avoid exposure to high temperatures, the pyrometer could also be positioned inside the reactor chamber with adequate distancing from the reaction zone and a custom high temperature design. Gases produced during the extraction process are monitored with an optical gas sensor mounted in-line with the gas outlet stream, serving as the primary method for monitoring oxygen production downstream of the reactor. SOA optical sensors are available commercially for measuring a number of different product gases with high resolution and rapid response. The type of sensor used will depend on the extraction process and product gas types (O₂, CO, or H₂O vapor). A single FTIRS module will be used to periodically sample the mineral-oxide concentrations in the regolith both upstream (unprocessed) and downstream (processed) of the reactor, providing a secondary method for monitoring oxygen production and providing a direct measurement of extraction efficiency when comparing mineral-oxide content between the unprocessed regolith and the processed regolith. These oxygen content measurements by both direct gas analysis and by measurement of the mineral-oxide content of the solid forms will provide a means to identify process malfunction and system servicing requirements based on reduced extraction efficiency. The FTIRS method for measuring oxygen content in solids, including regolith, is a proven process and compact commercial modules with automated analysis are available for purchase. These types of systems can provide detailed analysis of material composition and report constituent quantities at >110 spectra/sec, which is more than adequate for providing high fidelity oxygen content monitoring at the desired 25 kg/hr processing rate. Periodic sampling will provide an average oxygen content value for both the processed and unprocessed regolith with high enough accuracy to quantify process performance.

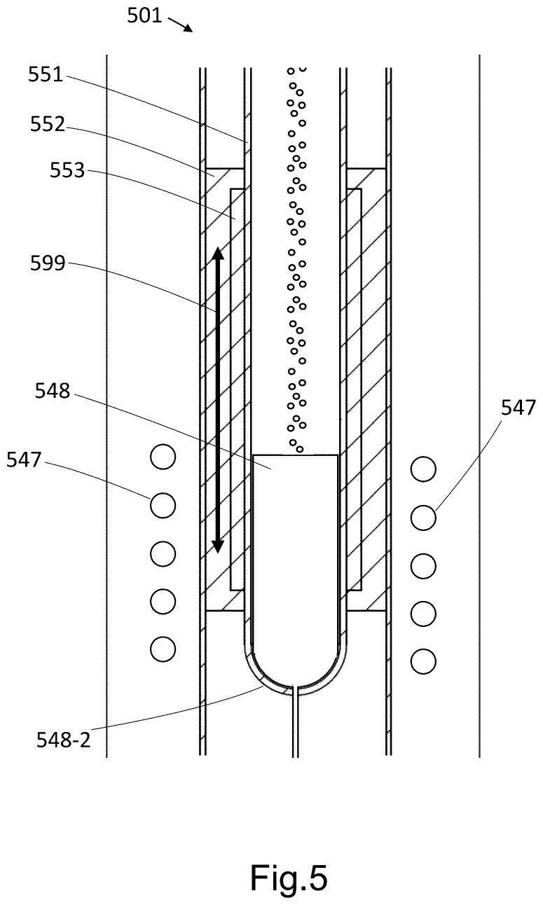

FIG. 5 depicts aspects of a slag extrusion seal system 501 used in embodiments of a regolith oxygen extraction system. Induction coils 547 provide heat to the alumina crucible 551, alumina jacket 552, and graphite susceptor 553. A melt pool 548 is shown formed at the bottom of the alumina crucible 551. Measurements of each of the melt pool surface temperature 548-1 and nozzle 548-2 may be monitored. The alumina jacket 552 and graphite susceptor 553 translate 599 up and down to provide controlled heating and cooling of the melt pool 548.

The slag extrusion seal system 501 is critical to enabling a continuous oxygen extraction process. Controlling the extrusion process is important for controlling the reaction and regolith dwell time for optimal oxygen yield. Controlling the extrusion is also important for developing alternative uses for the extruded material including part fabrication, long duration thermal energy storage, or for smelting and secondary refining.

Crucible nozzle temperature is the primary method to control the extrusion. Supplemental or alternative extrusion control methods include (1) pressure control within the reaction chamber (2) a vertically translating platform under the crucible nozzle that can be used to plug the orifice for start/stop protocols and limit the flow rate through vertical actuation, and (3) gravity induced pressure developed by the height of the column of material within the reactor.

Maintaining a constant level of molten regolith in the reaction chamber is required to maintain low leak rates through the extrusion subsystem. One needs to match the particle feed rate into the reactor with the melting rate and extrusion rate of the reaction chamber. To maintain the extrusion seal, two control schemes are implemented on the reactor chamber inlet and the crucible nozzle.

For the first control scheme, a two-color pyrometer is used to monitor the temperature of the reaction zone and a closed loop system is designed to maintain this temperature by varying the feed rate into the reaction zone. This control system ensures that the melt pool level never gets too low (indicated by high reaction zone temperature readings) or too high (indicated by low reaction zone temperature readings) which can cause regolith solidification and clogging of the crucible nozzle. This scheme is implemented instead of measuring the melt pool levels directly because of the harsh environment of the reaction zone.

The second control scheme is implemented at the crucible nozzle to control flow rate. This closed loop system also uses temperature at the end of the crucible nozzle to adjust the heat input into the nozzle to maintain a constant temperature. Because of the high viscosity of the molten regolith, the flow rate is highly dependent on the temperature of the nozzle. Higher temperatures will create faster flow rates and vice versa. By adjusting the susceptor position up and down relative to the crucible, the heat input to the nozzle will be varied. An additional heating mechanism, e.g. an electrical heating element, may be implemented around the nozzle and controlled in the same fashion through temperature feedback. Two additional nozzle control methods may be used. The first method observes the effects of pressure differential on the extrusion rate. Higher pressure differentials are expected to have higher extrusion rates, but this may result in additional gas leaking out of the nozzle. A translating platform may be placed below the nozzle to provide back pressure to the system during extrusion.

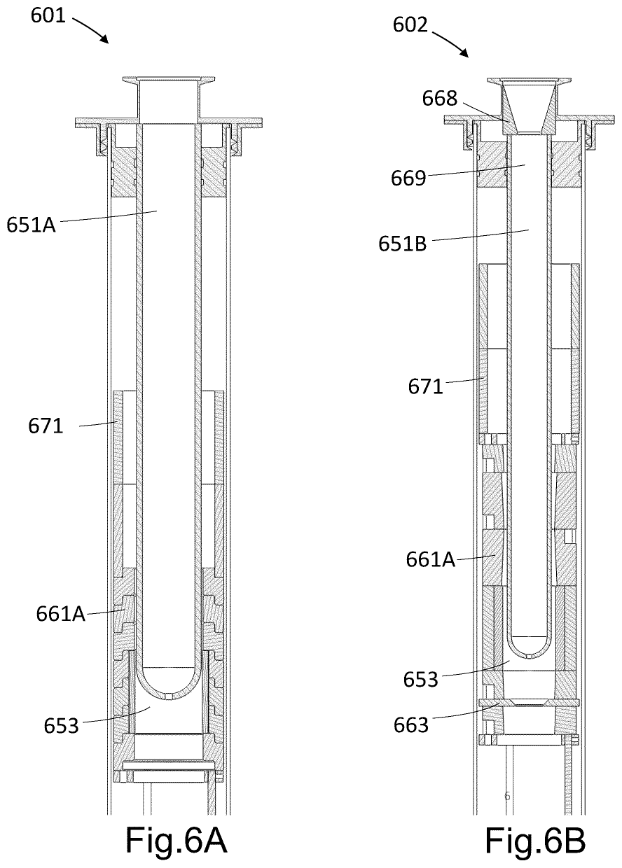

FIGS. 6A-B depict two experimental prototype designs 601, 602 respectively of the extrusion portion of a regolith oxygen extraction system.

The extrusion portion 601 comprises a 2 inch zirconia crucible 651A, stainless steel counterweights 671, a set of stacked zirconia insulation rings 661A, and a graphite susceptor 653. The extrusion portion 602 is similar to the extrusion portion 601 yet comprises a 1.5 inch alumina crucible 651B instead of a 2 inch zirconia crucible 651A and some other design differences. The smaller diameter crucible allows a thicker insulation jacket made from graphite felt insulation 662 and cast zirconia component such as zirconia insulation 661B. A custom adapter 669 and a zirconia funnel 668 are fitted to the upper portion of the alumina crucible 651B. The extrusion portion 602 comprises stainless steel counterweights 671, an inner quartz tube 680, and additional nozzle insulation 663.

In both designs of extrusion portion 601 and extrusion portion 602, unimpeded susceptor 653 translation is achieved by implementing a stacked zirconia jacket design (661A, 661B, respectively) with stainless steel counterweights 671 on top.

FIG. 7 depicts another experimental prototype design of the extrusion portion 1301 of a regolith oxygen extraction system. The figure presents a slag extrusion seal subsystem 1301 with three actuation mechanisms. Generally, by adjusting the susceptor of a regolith oxygen extraction system up and down, the heat input to the nozzle is varied. Because the susceptor is suspended around the crucible with no physical connection needed to the induction coils or the crucible, its translation in the vertical direction may be achieved with a vertically translating susceptor platform. This susceptor platform is in addition to a vertically translating extrusion platform. Note that there are other means to heat the susceptor as known to those skilled in the art, e.g. microwave energy means.

In one embodiment, a regolith oxygen extraction system comprises a crucible-nozzle assembly design that enables induction heating without susceptor contact with reactor load, i.e., the design comprises a refractory crucible liner, graphite susceptor, and insulating jacket set of components.

A susceptor actuator 1355A translates a susceptor platform 1355 of the susceptor 1353 relative to the crucible nozzle for controlling the extrusion rate based on nozzle temperature. A vertically translating platform 1357 actuated by a translating platform actuator 1357A limits the extrusion rate through physical contact with the molten regolith. And a rotary platform actuator 1356A actuates a rotary platform 1356 that works in coordination with the vertical translating platform 1357 to limit flow while also rotating to allow regolith to be extruded to form cylindrical shapes via an additive manufacturing method while enabling a more compact design of the slag collection volume. A load cell is implemented to monitor extrusion rate from an extrusion nozzle.

FIG. 8 depicts a spectroscopy system 890 engaged with an experimental prototype design of a regolith oxygen extraction system 800. The spectroscopy system 890 allows a single spectrometer (Raman or other) to be used for measuring composition of pre-processed and processed material at multiple locations within regolith oxygen extraction system using a beam redirecting system through use of actuated mirrors or beam splitters. This avoids the need for multiple spectrometers throughout the system.

A Raman spectrometer and beam redirecting measurement system 890 is shown coupled with a FaRROE prototype 800. For measuring the inlet regolith stream (at 891M), mirror one 895 is positioned out of the spectrometer's notional beam path 891 (of spectrometer 899) to allow the laser light to pass through the vertical tube hopper wall (polycarbonate) and excite the unprocessed regolith. Raman shifted light is then emitted by the regolith and follows the same beam path to the spectrometer for analysis. For measuring the outlet regolith stream (at 893M), mirror one 895 is translated down (895T) to intercept the spectrometer notional beam path 891 and redirect the beam (shown as redirected beam 892) to mirror two 896 which redirects the beam 892 to pass through the outlet chamber wall (quartz) and excite the processed regolith (to obtain measurement 893M). Again, Raman shifted light is then emitted by the regolith and follows the same beam path to the spectrometer 899 for analysis. Translation 896T of mirror two 896 allows for characterizing the spectrometer's ability to measure oxide content on different forms of processed regolith ranging from hot molten regolith (at the reactor extrusion point) to cool solidified regolith (at the bottom of the outlet chamber).

More generally, the single Raman spectroscopy module 899 is used to periodically sample the mineral-oxide concentrations in the regolith both upstream (unprocessed) and downstream (processed) of the reactor, providing a secondary method for monitoring oxygen production and providing a direct measurement of extraction efficiency when comparing mineral-oxide content between the unprocessed regolith and the processed regolith. These oxygen content measurements by both direct gas analysis and by measurement of the mineral-oxide content of the solid forms provide a means to identify process malfunction and system servicing requirements based on reduced extraction efficiency. Periodic sampling provides an average oxygen content value for both the processed and unprocessed regolith with high enough accuracy to quantify process performance.

In some embodiments, one or more hopper obstructions are configured to fit within the vertical tube hopper to facilitate a gas seal in the vertical tube, such a seal restricting or mitigating or preventing a backflow of oxygen up the vertical tube hopper. For example, a pair of hopper obstructions may serve to prevent upward regolith flow and enable higher seal pressures. Implementing flow restrictors and hopper obstructions inside the vertical tube hopper prevents regolith from rising in bulk packets as pressurized gas applies a force from the bottom of the regolith while still allowing for downward flow of regolith through the restrictor. The flow restrictor of the prototype system implemented a funneling mesh design where the open area of each gap within the mesh is larger upstream and funnels down to a smaller opening downstream. This provides minimal obstruction for downward flow and a large obstructive surface for upward flow of regolith. Testing with the prototype system confirmed this assessment by preventing the upward flow of regolith packets normally seen for feed rates above 1,000 g/hr beyond any single flow restrictor within the hopper as gas associated with the vertical tube hopper's leak rate passes upward through the regolith. The use of four flow restrictors enabled continuous feeds of up to, for example, 3,450 g/hr with a 208 Torr pressure differential to be maintained with a measured gas leak rate of 1.47 g/hr.

In some embodiments, one or more flow restrictors, such as directionally biased flow restrictors, within vertical tube hopper operate in any of several modes, such as static (no movement) or dynamic in coordinated operation (e.g., the set of restrictors move at the same time or in a set sequence) or as a time-varying manner per a selected schedule. The dynamic flow restrictors may be operated or controlled remotely by an operator or operate automatically to a set operating schedule.

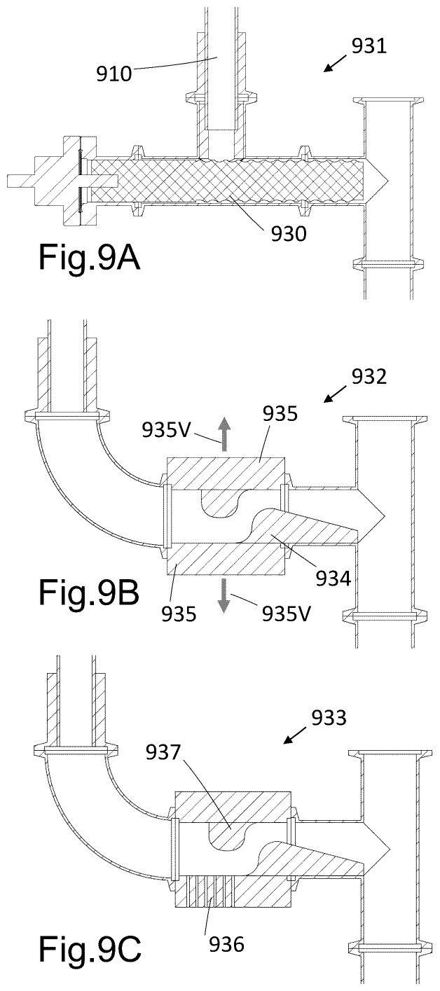

FIGS. 9A-C and 10 depict various embodiments of the vertical tube hopper engaged with a conveyor (aka a “vertical tube hopper seal” subsystem) that, among other things, operate to mitigate clogging of the regolith stream of particles entering the reaction chamber and serve to form or promote a fluid or gas seal to retard or mitigate or prevent backflow of oxygen up the vertical tube hopper and of the system. Generally, an agitator element of a conveyor is used to promote fluidization at the outlet and prevent clogging while a weir element is used to prevent backflow of particles.

The vertical tube hopper seal subsystem (931 in FIG. 9A) may be broken down into two main components: the vertical tube hopper and the horizontal conveyor. The vertical tube hopper 910 of FIG. 9A acts as a regolith reservoir and forms the gas seal between the reaction chamber and the outside environment. The horizontal conveyer 930 is located at the bottom of the vertical tube hopper 910 and conveys regolith from the hopper into the reaction zone.

Another embodiment of a vertical tube hopper seal subsystem (932 in FIG. 9B) is designed to remove all dynamic contact with the regolith and therefore drastically improve the lifetime of the system by preventing wear to moving components. A vibratory feed mechanism 935 providing vibration 935V transports regolith from the hopper to the reaction chamber. This conveyer uses a weir 934 along with vibration to fluidize the regolith particles and control feed rate. Vibratory feeds are a commonly used method of transporting particles in industry. In addition to the benefit of no moving parts touching regolith, the system does not require gas flow for fluidization which minimizes resource requirements for a lunar system and can be used for vacuum pyrolysis.

Yet another embodiment of a vertical tube hopper seal subsystem (933 in FIG. 9C) is a “loop seal” design with loop seal 937. A loop seal is commonly used in industry for circulating fluidized beds (CFB). In CFB's the loop seal is used to convey particles from an area of low pressure into an area of high pressure. The device is similar to the vertical tube hopper with vibrating conveyor of FIG. 9B, but instead of using vibration to convey the particles, a gas is pumped into the regolith through a porous membrane 936 to fluidize the particles. This gas fluidization method might be of interest for oxygen extraction methods where a reactant gas must be introduced into the system. This system would provide good mixing of the gas and regolith as well as potentially preheating the regolith in the process.

In one embodiment to address and mitigate clogging of regolith, a slight variation of the vertical tube hopper design implements mechanical gate valves at the top and bottom of the hopper to completely seal the system from leaking. This design uses two hoppers so that as one hopper is being refilled the other can continue operating, providing continuous feed to the system. The advantage of this system is the seal rating common to mechanical valves that minimizes leakage out of the system. Gate valves may be used for this design which have been well established for sealing high vacuum systems.

Note that the various anti-clogging features described above regarding the vertical hopper and the conveyor may be combined, e.g. a vibration feature may be combined with a weir feature. A vibrating weir design may be used for conveying regolith or other granular material horizontally in a controlled fashion, notionally from the base of the vertical tube hopper into the reactor chamber. In conventional loop seal systems for granular material, aeration is used to fluidize the granular material to be conveyed. The combination of an internal weir and vibration-based fluidization is particularly useful when the reactor is operating at low absolute pressures, has a highly controlled internal gas environment, or where availability of a carrier gas is limited such as on the Moon.

In some embodiments, akin to the inclusion of the flow restrictors, the various flow features of the vertical tube hopper seal subsystem and/or conveyor may operate in any of several modes, such as static (no movement or operation, e.g. no vibration) or dynamic in coordinated operation (e.g., a set of tappers or vibrators move at the same time or in a set sequence) or as a time-varying manner per a selected schedule. The features may be operated or controlled remotely by an operator or operate automatically to a set operating schedule.

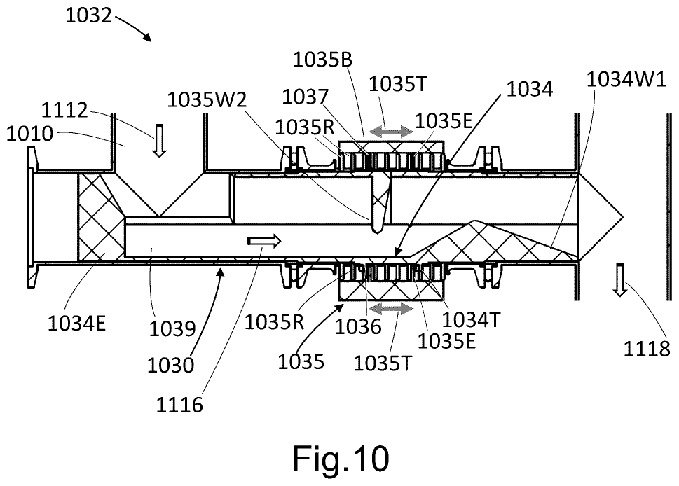

FIG. 10 depicts a cross-sectional view of creating a vertical tube hopper (gas) seal of a regolith oxygen extraction system. The combined weir 1034 and bellows 1035 elements of the vertical tube hopper 1032 enable or provide fluidization of granular material while sustaining a gas seal (i.e., mitigating or reducing or stopping backflow of oxygen into the vertical tube column stream of regolith). In conventional particle transfer loop seal systems, aeration is used to fluidize the granular material to be transferred, and a weir is used to limit and control granular flow through the outlet. The bellows with weir design 1032 and enable fluidization with a reduction in system complexity and consumables.

The vertical tube hopper seal assembly 1032 uses a rigid bellows hose 1035 to provide horizontal motion of the weir 1034 without vibrating the vertical tube hopper 1010. Particles flow 1112 from the vertical tube hopper 1010 into the conveyor 1039, in turn flowing 1116 until departing the conveyor at flow 1118.

The weir components comprise a first (upper) weir extension 1035W2 and a lower weir extension 1034W1. The weir 1034 is translated 1035T by bellows 1035.

The bellows 1035 comprises external bellows ribs 1037 attached to bellows base 1035B, the external bellows ribs 1037 translating 1035T so as to engage and translate internal bellows interface ribs 1036. The internal bellows interface ribs 1036 are attached to the weir 1034 and thus, when the external bellows ribs 1037 translate 1035T, the weir 1034 also translates. A set of flexible bellows ribs 1035R are fitted and positioned between the bellows base 1035B and the weir 1034. The translation 1035B of the weir 1034 facilitates the prevention of clogging of the particles flowing 1116 through the conveyor 1039.

The bellows interfaces such as flexible bellows ribs 1035R are positioned to increase the number of flexible ribs. An extended weir inlet 1034E prevents regolith from getting into the bellows ribs.

In one embodiment of a granular regolith seal (for the vertical tube hopper), an Olds elevator design is employed. The Olds elevator entails rotation of the casing around a stationary auger. Advantages of this method include the ability to drive the casing externally and at a distance from the ground, meaning drive mechanisms can be isolated from regolith exposure completely. Additionally, unlike the enclosed auger, actuation is not limited to the extreme ends of the system and can therefore reduce torsional loading throughout the component length. Casing-driven elevators operate with a higher volumetric fill than auger-driven elevators, which increases system load but improves potential for pressure-sealing application. For the regolith extraction system, an Olds Elevator design is used for the granular regolith seal where the Olds Elevator is operated at a highly-packed condition such that the regolith makes a gas seal; one can then convey regolith directly from a ground position into the reactor, rather than having to convey it from the ground to the top of a vertical tube hopper and then down into the reactor. (See Olds, R. (2006). A Radical Approach to the Vertical Conveyance of Bulk Materials: the Olds Elevator. Houston Material Handling Society, incorporated by reference in entirety for all purposes).

In one embodiment of the regolith oxygen extraction system, one or more of the following features and/or elements are provided:
XY translation stage on vertically translating extrusion platform to enable 3D printing with extruded slag.
Casting molds placed on vertically translating extrusion platform for producing cast components.
Series of 1 or more tapping agitators along vertical tube hopper positioned and sequenced to promote downward flow of regolith while minimizing gas flow through the regolith in the opposite direction.
A non-contact laser spectroscopy system (Raman or other) coupled with a beam redirecting system to measure oxide content in unprocessed and processed regolith streams at the same time with a single spectrometer.
   Beam redirecting system implements an actuated mirror to redirect the laser beam (and reflected/emitted spectra) and alternate between the regolith inlet and the regolith outlet for making spectral measurements.
   Spectra measurements used to quantify mineral oxide content as an indirect measurement of O2 content
An auger within the vertical tube column
Load cell to measure extruded mass
Refractory plug on vertically translating extrusion platform to plug orifice for start stop capability.

In some embodiments, the regolith oxygen extraction system may operate with any granular particle stream.

In some embodiments, a second vertical hopper may be installed at the reactor outlet of a regolith oxygen extraction system in situations in which the processed granular material is not brought to a molten state. Also, a second vertical hopper may be used for removing a mixed molten/solidified/granular material stream outlet to obviate material selection challenges that may arise when handling issues generated by a molten material extrusion nozzle interacting with a high temperature molten material.

In some embodiments, the control of the rate of molten regolith extrusion is provided by the control of heat provided to at least one of the extrusion nozzle and the reactor chamber, the heat produced by at least one of induction coils, a resistive wire, and a microwave source.

In some embodiments, a reaction temperature is controlled through increasing or decreasing the regolith inlet feed rate; if reaction temperature gets too high, increase feed rate and vice versa.

In some embodiments, a mobile, continuous, sealed reactor is possible where a horizontal regolith tube inlet is driven into the ground in front of a mobility platform to gather regolith. The regolith is forced into the reactor through motion of the vehicle while maintaining a gas seal at the inlet. The reacted material—either granular or a mixed molten/solidified and granular mixture—is then removed from the reactor via a regolith tube outlet.

Note that other methods of use of the disclosed regolith oxygen extraction system are possible. Also, any of the steps, functions, and operations discussed herein can be performed continuously and automatically. In some embodiments, one or more of the steps of the method of use may comprise computer control, use of computer processors, and/or some level of automation.

The exemplary systems and methods of this disclosure have been described in relation to systems and methods involving a regolith oxygen extraction system. However, to avoid unnecessarily obscuring the present disclosure, the preceding description omits a number of known structures and devices, and other applications and embodiments. This omission is not to be construed as a limitation of the scope of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A regolith oxygen extraction system comprising:
a vertical tube hopper defining a hopper volume and configured to receive a first regolith stream at a hopper inlet and output the first regolith stream at a hopper outlet;
a conveyor configured to transport the first regolith stream at or adjacent the hopper outlet to form a regolith reaction stream;
a reactor chamber having a chamber enclosed volume and configured to receive the regolith reaction stream, transfer heat to the chamber enclosed volume, output a molten regolith stream, and output a production oxygen stream;
an extrusion nozzle configured to extrude the molten regolith stream; and
a controller configured to control at least an extrusion rate of the molten regolith stream;
wherein:
the first regolith stream flows from the hopper inlet to the hopper outlet;
the heat transferred to the regolith reaction stream contained within the chamber enclosed volume produces a reaction at a reaction zone that creates molten regolith and oxygen;
the molten regolith stream formed from the molten regolith exits the reaction chamber at an extrusion rate through the extrusion nozzle;
the oxygen forms the production oxygen stream that exits the reaction chamber at an oxygen production rate through an oxygen outlet and forms a backflow oxygen stream that flows at least from the hopper outlet to the hopper inlet;
the first regolith stream forms a gas seal within the hopper volume that restricts the backflow oxygen stream and reduces a backflow oxygen stream flow rate of the backflow oxygen stream; and
the molten regolith stream forms a liquid seal that restricts the oxygen from exiting through the extrusion nozzle.

2. The regolith oxygen extraction system of claim 1, further comprising one or more agitation mechanisms coupled to the vertical tube hopper, the one or more agitation mechanisms operating to mitigate clogging of the first regolith stream.

3. The regolith oxygen extraction system of claim 1, further comprising at least one of a temperature sensor configured to measure a reactor chamber temperature, an optical sensor configured to measure an oxygen concentration of the production oxygen stream, a first Raman spectrometer, a Raman-comparable device for performing spectral analysis configured to measure a mineral-oxide content of the first regolith stream, a second Raman sensor configured to measure a mineral-oxide content of the molten regolith stream, a third Raman sensor configured to measure a mineral-oxide content at a selected location, and a fourth Raman sensor configured to measure a mineral-oxide content at multiple selected locations.

4. The regolith oxygen extraction system of claim 1, wherein the heat transferred to the chamber enclosed volume is provided by one of a solar-thermal means, a laser heating means, an electrical-resistive means, an induction means, an electrical Joule heating means, and a microwave means.

5. The regolith oxygen extraction system of claim 1, wherein the backflow oxygen stream rate is less than 1% of the oxygen production rate.

6. The regolith oxygen extraction system of claim 1, wherein a rate of flow of the oxygen stream exiting through the extrusion nozzle is less than 1% of the oxygen production rate.

7. The regolith oxygen extraction system of claim 1, wherein the regolith is lunar regolith.

8. A method of using a regolith oxygen extraction system comprising:
providing a regolith oxygen extraction system comprising:
a vertical tube hopper defining a hopper volume and having a hopper inlet and a hopper outlet;
a conveyor;
a reactor chamber having a chamber enclosed volume and an oxygen outlet;
an extrusion nozzle in fluid communication with the reactor chamber; and
a controller;
supplying a first regolith stream to the hopper inlet;
flowing the first regolith stream from the hopper inlet to the hopper outlet;
receiving the first regolith stream by the conveyor at or adjacent to the hopper outlet to form a regolith reaction stream;
transporting the regolith reaction stream to a regolith reaction stream port;
flowing the regolith reaction stream from the regolith reaction stream port to the chamber enclosed volume;
forming molten regolith and oxygen by applying heat to the regolith reaction stream to cause a reaction in a reaction zone;
extruding the molten regolith through the extrusion nozzle; and
outputting the oxygen through the oxygen outlet.

9. The method of claim 8, further comprising the step of agitating the first regolith stream using an agitation mechanism coupled to the vertical tube hopper, the agitation mechanism mitigating clogging of the first regolith stream.

10. The method of claim 9, wherein the agitation mechanism is a set of agitation mechanisms that operate at least in a unison mode and a time varying mode.

11. The method of claim 8, further comprising the step of controlling a rate of molten regolith extrusion through the extrusion nozzle, the rate of molten regolith extrusion controlled by control of at least one of: control of an extrusion nozzle temperature and a reactor chamber internal pressure.

12. The method of claim 8, further comprising the step of controlling a rate of molten regolith extrusion through control of heat provided to at least one of the extrusion nozzle and the reactor chamber, the heat produced by at least one of induction coils, a resistive wire, and a microwave source.

13. The method of claim 8, wherein the heat applied to the regolith reaction stream is provided by one of a solar-thermal means, a laser heating means, an electrical-resistive means, an induction means, an electrical Joule heating means, and a microwave means.

14. The method of claim 8, wherein the vertical tube hopper of the regolith oxygen extraction system further comprises a set of directionally biased flow restrictors that increase a differential pressure of the regolith oxygen extraction system.

15. The method of claim 8, wherein the regolith oxygen extraction system further comprises a crucible configured to contain the molten regolith, induction coils or microwave source configured to generate induction or microwave heat, and a susceptor positioned radially exterior to the crucible.

16. The method of claim 15, further comprising the step of vertically translating the susceptor to provide at least one of: i) controlled heating of the molten regolith, and ii) flow control of the molten regolith extruding through the extrusion nozzle by controlling nozzle temperature.

17. The method of claim 8, further comprising the step of controlling a temperature of the molten regolith by control of a flow rate of the first regolith stream.

18. The method of claim 8, wherein the conveyor comprises an agitation mechanism operating to fluidize and promote forward flow of the regolith reaction stream and at least one weir to control forward flow and prevent backflow of the first particle stream.

19. A particle and gas extraction system comprising:
a vertical tube hopper having a hopper volume and configured to receive a first particle stream at a hopper inlet and output the first particle stream at a hopper outlet;
a conveyor configured to transport the first particle stream at or adjacent the hopper outlet to form a particle reaction stream;
a reactor chamber having a chamber enclosed volume and configured to receive the particle reaction stream, transfer heat to the chamber enclosed volume, output a molten particle stream, and output a production gas stream;
an extrusion nozzle configured to extrude the molten particle stream; and
a controller configured to control at least an extrusion rate of the molten particle stream;
wherein:
the first particle stream flows from the hopper inlet to the hopper outlet;
the heat transferred to the particle reaction stream contained within the chamber enclosed volume produces a reaction at a reaction zone that creates molten particles and a gas;
the molten particle stream formed from the molten particles exits the reaction chamber at an extrusion rate through the extrusion nozzle;
the gas forms the production gas stream that exits the reaction chamber at a gas production rate through a gas outlet and forms a backflow gas stream that flows at least from the hopper outlet to the hopper inlet;
the first particle stream forms a gas seal within the hopper volume that restricts the backflow gas stream and reduces a backflow gas stream flow rate of the backflow gas stream; and
the molten particle stream forms a liquid seal that restricts the gas from exiting through the extrusion nozzle.

20. The particle and gas extraction system of claim 19, further comprising a tube outlet connected to the reaction chamber and configured to output any mixed granular material formed from the molten particles.
